(19) United States
(12) Patent Application Publication
(10) Pub. No.: US 2026/0312330 A1
(43) Pub. Date: Oct. 8, 2026

(54) INLAYS FOR MODULAR CONNECTORS

(71) Applicant: Aptiv Technologies AG, Schaffhausen (CH)

(72) Inventors: Andreas URBANIAK, Münster (DE); Markus GAERTNER, Wuppertal (DE); Vijay Babu MOORTHY, Tamil Nadu (IN); Uvaraj GANESAN, Tamil Nadu (IN); Rajan KUMARESH, Tamil Nadu (IN); Achim ROSEMANN, Wuppertal (DE)

(21) Appl. No.: 19/549,238

(22) Filed: Feb. 25, 2026

(30) Foreign Application Priority Data
Apr. 4, 2025 (EP) 25168569.9

(51) Int. Cl. H01R 13/514; H01R 13/52

(52) U.S. Cl. CPC H01R 13/514; H01R 13/521

(57) ABSTRACT

A connector assembly includes a housing and a plurality of inlays, each inlay configured to receive two terminals of a twisted wire pair cable. The housing has a plurality of inlay reception chambers that receive the inlays, allowing for organized terminal management. This design enables a compact and efficient connector configuration, facilitating reliable connections between terminals.

### CROSS-REFERENCE TO RELATED APPLICATION

This application claims the benefit of and priority to European Application No. 25168569.9 filed with the European Patent Office on Apr. 4, 2025, the contents of which are incorporated by reference herein.

### TECHNICAL FIELD

The present disclosure relates to a connector assembly and a method for connecting inlays with twisted wire pairs. Specifically, the present disclosure pertains to a modular connector assembly with a housing including inlay reception chambers and sub-housings with connection features, and a method for integrating twisted wire pairs into the assembly.

### BACKGROUND

In the field of electrical connectors, it is common to use connector assemblies that facilitate the connection of cables and terminals for various applications, including telecommunications, automotive, and industrial systems. Known systems typically involve complex housing structures that accommodate multiple terminals and cables, often requiring precise alignment and secure retention to ensure reliable electrical connections. These systems often utilize intricate designs that can be challenging to assemble and maintain, for instance in automated manufacturing environments.

Traditional connector assemblies often rely on fixed housing designs that limit flexibility and adaptability. The integration of terminals and cables into these housings can be cumbersome, requiring manual intervention to ensure proper alignment and secure retention. This can lead to increased assembly time and potential errors, particularly when dealing with high-density connectors that require precise positioning of multiple terminals. Additionally, the need for manual assembly processes can increase production costs and limit scalability in high-volume manufacturing settings.

Despite the substantial advances in the field of electrical connectors, there remains a need for more efficient and flexible systems that can accommodate various terminal configurations and cable types. Current approaches often lack modularity, making it difficult to adapt to different application requirements without significant redesign or customization. This lack of modularity can also hinder the ability to automate the assembly process, as traditional designs may not be compatible with automated equipment or processes.

Furthermore, existing connector assemblies may not adequately address the challenges associated with maintaining secure and reliable connections in dynamic environments. Factors such as vibration, temperature fluctuations, and mechanical stress can compromise the integrity of electrical connections, leading to potential failures or performance issues. As such, there is a growing demand for connector systems that offer enhanced reliability and durability, particularly in demanding applications where environmental conditions can vary significantly.

It is therefore a technical problem underlying the present invention to provide a connector assembly that at least partially overcomes the disadvantages of known systems.

### SUMMARY

A connector assembly includes a housing and a plurality of inlays. Each inlay is configured to receive two electrical terminals, and the housing defines a plurality of inlay reception chambers configured to receive the inlays.

In some embodiments, the housing includes retaining features configured to retain the inlays within their respective inlay reception chambers. Each terminal may be crimped onto a cable, and in some embodiments the cable is part of a twisted wire pair, with each inlay configured to receive two terminals associated with the twisted wire pair.

In some embodiments, at least one inlay includes a rear grid disposed on a rear side of the inlay, the rear grid defining a plurality of feed-through apertures configured to receive electrical contacts; a sealing insert mountable to the rear grid and defining feed-through holes for receiving the electrical contacts; and an elongated insert module mountable to the sealing insert, such that the sealing insert is sandwiched between the rear grid and the elongated insert module, the elongated insert module defining at least two cavities configured to receive the electrical contacts.

In some embodiments, the inlay has a substantially flat rectangular shape having a length in an insertion direction, a height, and a width, wherein a ratio of the length to the height and/or the length to the width is at least 7:1, and optionally at least 9:1, at least 11:1, or at least 13:1. In some embodiments, each inlay defines two channels extending in the insertion direction from one end of the inlay to an opposite end for receiving electrical contact terminals.

In some embodiments, at least one inlay has a T-shape, with coding feature and fixing feature arranged in a bar of the T-shape. In some embodiments, the housing includes a terminal position assurance (TPA) device, and/or each inlay includes a TPA device.

In some embodiments, the housing is formed from at least two matching sub-housings, each including sub-housing connection features configured to fit together to form the housing. The sub-housing connection features may include dovetail joints, including sliding dovetail joints, and may further include locking feature configured to lock the sub-housings in a final assembled position.

In some embodiments, the inlays include polarization feature configured to permit insertion into the inlay reception chambers in only one orientation. The polarization feature may include a polarization rib extending axially in a mating direction of the inlays.

A method of connecting an inlay with a twisted wire pair includes providing the inlay, the twisted wire pair, and a twisting machine; twisting the wire pair using the twisting machine; connecting the inlay with the twisted wire pair without removing the wire pair from the twisting machine; and, after connecting the inlay with the twisted wire pair, mounting the inlay into the housing. In some embodiments, the twisting machine includes a gripping device configured to engage the twisted wire pair at the beginning, during, and/or at the end of connecting the inlay with the twisted wire pair.

### BRIEF DESCRIPTION OF THE DRAWINGS

Other features, details, and advantages of the disclosure will become more apparent from the detailed illustrative description given hereafter with respect to the drawings in which:

FIG. 1 shows an exploded view of a connector assembly with a housing and inlays according to some embodiments.

FIG. 2 shows an exploded view of an inlay with a rear grid, sealing insert, and elongated insert module according to some embodiments.

FIG. 3 shows an exploded view of a connector assembly with a housing and an inlay being inserted into the housing according to some embodiments.

FIG. 4a shows an isometric view of a sub-housing with connection features and locking features according to some embodiments.

FIG. 4b shows an isometric view of a sub-housing with dovetail joints and connection features according to some embodiments.

FIG. 5a shows an assembly of inlays with twisted wire pairs on a twisting machine according to some embodiments.

FIG. 5b shows an assembled inlay with a twisted wire pair on a twisting machine according to some embodiments.

### DETAILED DESCRIPTION

The subsequent paragraphs provide a detailed description of embodiments of the invention, referencing the accompanying illustrations for clarity. The descriptions represent examples only and are not intended to limit the invention's scope. Identical reference numerals across the figures and text denote the same components. The illustrations may not reflect actual size or scale; their dimensions, proportions, and depictions of elements might be enhanced for better understanding and visual convenience.

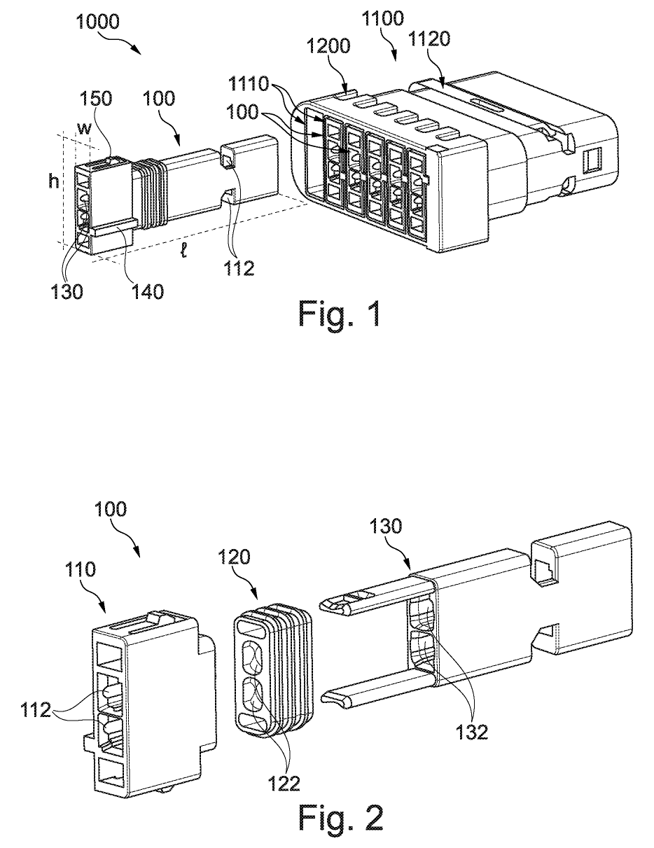

FIG. 1 shows a connector assembly 1000 including a housing 1100 and several (six) inlays 100. The housing 1100 includes inlay reception chambers 1110, which are configured to receive the inlays 100. The housing 1100 is depicted as an essentially rectangular block with multiple (six in the shown example) chambers 1110 arranged in a grid pattern at one side. Each chamber 1110 is designed to accommodate one inlay 100. The housing 1100 also features retaining features 1200, which are mechanisms designed to hold the inlays 100 securely within their respective chambers 1110. Additionally, the housing 1100 includes TPA devices 1120, which are secondary locking mechanisms to ensure the inlays (and preferably also the terminals received in said inlays) are fully seated and locked in place.

The shown inlay 100 is a substantially flat rectangular component with a length l, height h, and width w, where the ratio of l/w is at least 7. The inlay 100 has a T-shape, with coding feature 140 and fixing feature 150 arranged in the bar of the T-shape. The inlay 100 also includes channels extending in the insertion direction from one end of the inlay to the opposite end, designed for the reception of electrical contact terminals. The inlay 100 is configured to receive two terminals that are for instance part of a twisted wire pair cable.

FIG. 2 illustrates an exploded view of the inlay 100, showing its components in detail. The inlay 100 includes a rear grid 110, a sealing insert 120, and an elongated insert module 130. The rear grid 110 is disposed on the rear side of the inlay 100 and features a plurality (two in the shown embodiment) of feed-through apertures 112 configured to receive electrical contacts. The sealing insert 120, preferably made of an elastomeric material, is mountable to the rear grid 110 and has a plurality (two in the shown embodiment) of feed-through holes 122 for receiving the electrical contacts. The elongated insert module 130 is mountable to the sealing insert 120, sandwiching the sealing insert 120 between the rear grid 110 and the elongated insert module 130. The elongated insert module 130 includes two cavities 132 configured to receive electrical contacts.

The feed-through apertures 112 in the rear grid 110 are small, evenly spaced holes that align with the feed-through holes 122 in the sealing insert 120. The sealing insert 120 fits snugly against the rear grid 110. The elongated insert module 130 is a rectangular component with two elongated cavities 132 designed to house the electrical contacts. The cavities 132 extend longitudinally along the length of the insert module 130, providing a secure channel for the electrical contacts.

The housing 1100 and inlay 100 are designed to work together to provide a secure and reliable connection for electrical contacts. The housing 1100's inlay reception chambers 1110 and retaining features 1200 ensure that the inlays 100 are held firmly in place, while the TPA devices 1120 provide an additional layer of security. The inlay 100's rear grid 110, sealing insert 120, and elongated insert module 130 work together to protect and organize the electrical contacts, ensuring a reliable connection. The T-shaped design of the inlay 100, along with the coding feature 140 and fixing feature 150, ensures that the inlay 100 can only be inserted in the correct orientation, preventing incorrect connections.

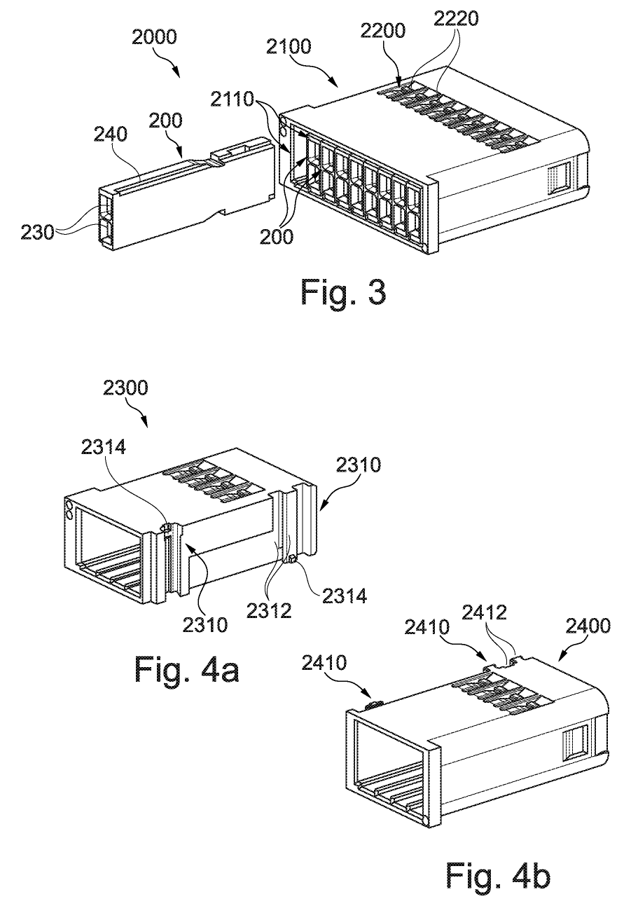

FIG. 3 illustrates a connector assembly 2000 with a housing 2100 and inlays 200. The retaining feature 2200 is located on the top surface of the housing 2100. It consists of a series of parallel hooks 2220 extending longitudinally along the surface in mating direction of the inlays. These hooks are evenly spaced and retain the inlays within their respective reception chambers. The hooks are aligned in the direction of insertion, providing a secure grip on the inlays and preventing them from moving or becoming dislodged once inserted into the housing. The inlays include polarization feature in the form of a polarization rib 240, extending in insertion direction and further include channels 230 for the insertion of terminals.

FIGS. 4a and 4b illustrate sub-housings 2300 and 2400 respectively, which may form part of the housing 2100. Each sub-housing 2300, 2400 includes sub-housing connection features 2310, 2410 that allow the sub-housings to fit together like two pieces of a jigsaw puzzle. The sub-housing connection features 2310, 2410 include dovetail joints 2312, 2412, which are preferably sliding dovetail joints. Additionally, the sub-housing connection features 2310, 2410 include a locking feature 2314 to lock the sub-housings 2300, 2400 in a final position, ensuring a secure and stable connection between the sub-housings. The locking feature 2314 is a locking mechanism that is integrated into the side of the sub-housing 2300. It is characterized by a protruding structure that extends outward from the side surface of the sub-housing. This protrusion has a rectangular shape with a flat top and bottom surface, and it includes a small notch or indentation that is designed to engage with a corresponding feature in form of a snap-fit on another component to secure the sub-housing in place. The overall shape of the locking feature 2314 ensures that it can effectively lock the sub-housings together when they are assembled.

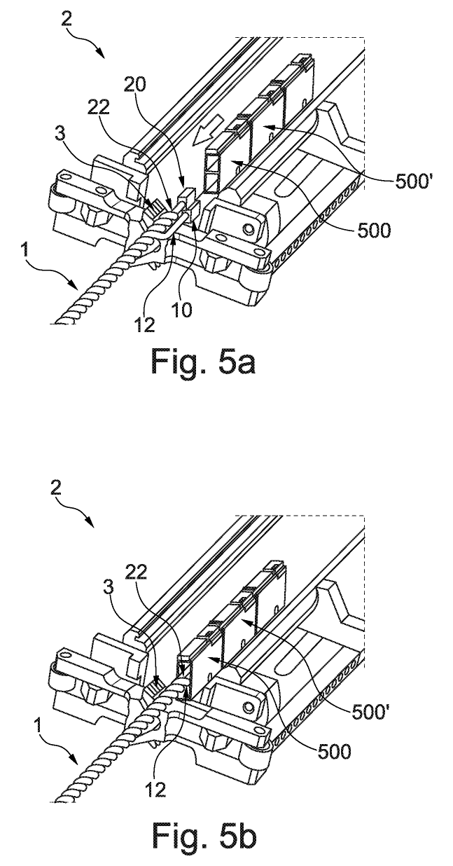

FIG. 5a illustrates a connector assembly in the process of connecting a twisted wire pair with an inlay. The twisted wire pair 1 is shown entering a twisting machine 2. The twisting machine 2 is designed to twist the individual wires 12 and 22 of the twisted wire pair 1. The individual wires 12 and 22 extend towards the inlays 500 and 500' arranged on the twisting machine 2. The gripping device 3, part of the twisting machine 2, is a clamp-like structure that holds the wires in place, ensuring stability during the connection process. The gripping device 3 secures the twisted wire pair 1, maintaining the position of the wires 12 and 22 as they approach the inlays 500 and 500'. The inlay 500 is depicted as a rectangular component with a substantially flat shape, configured to receive terminals 10 and 20, crimped onto the ends of wires 12 and 22. The terminals 10 and 20 are shown as elongated elements extending from the ends of the wires 12 and 22, respectively. The inlay 500' is similarly structured and positioned right behind inlay 500, as a serial arrangement for subsequent connection. The twisted wire pair 1 is thus held in place by the gripping device 3 while the inlays 500 can be mounted with the terminals 10 and 20.

FIG. 5b illustrates the setup of FIG. 5a, with the terminals 10 and 20 of the twisted wire pair 1 mated with (inserted in) the inlay 500. The twisted wire pair 1 is held in place by the gripping device 3 while the inlay 500 is mounted onto the terminals 10 and 20. FIGS. 5a and 5b collectively depict the process of connecting the twisted wire pair 1 with the inlays 500 using the twisting machine 2 and the gripping device 3.

While the invention has been described with reference to an exemplary embodiment(s), it may be understood by those skilled in the art that various changes may be made, and equivalents may be substituted for elements thereof without departing from the scope of the invention. In addition, many modifications may be made to configure a particular situation or material to the teachings of the invention without departing from the essential scope thereof. Therefore, it is intended that the invention is not limited to the disclosed embodiment(s), but that the invention will include all embodiments falling within the scope of the appended claims.

As used herein, ‘one or more’ includes a function being performed by one element, a function being performed by more than one element, e.g., in a distributed fashion, several functions being performed by one element, several functions being performed by several elements, or any combination of the above.

It may also be understood that, although the terms first, second, etc., are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a”, “an”, and “the” are intended to include the plural forms as well, unless the context clearly indicates otherwise. It may also be understood that the term “and/or” as used herein refers to and encompasses any and all possible combinations of one or more of the associated listed items. It may be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Additionally, while terms of ordinance or orientation may be used herein these elements should not be limited by these terms. All terms of ordinance or orientation, unless stated otherwise, are used for purposes distinguishing one element from another, and do not denote any particular order, order of operations, direction or orientation unless stated otherwise.

### REFERENCE NUMBER LIST

1 twisted wire pair
2 twisting machine
3 gripping device
10 terminal
12 cable
20 terminal
22 cable
100 inlay
110 rear grid
112 feed-through apertures
120 sealing insert
122 feed-through holes
130 elongated insert module
132 cavities
140 coding feature
150 fixing feature
200 inlay
230 channel
240 polarization feature
500 inlay
500’ inlay
1000 connector assembly
1100 housing
1110 inlay reception chambers
1120 TPA device
1200 retaining features
2100 housing
2110 inlay reception chambers
2200 retaining features
2220 hooks
2000 connector assembly
2300 sub-housing
2310 sub-housing connection features
2312 dovetail joints
2314 locking feature

What is claimed is:

1. A connector assembly, comprising:
a housing; and
a plurality of inlays, each inlay being configured to receive two terminals, wherein the housing comprises inlay reception chambers configured to receive the inlays.

2. The connector assembly according to claim 1, wherein the housing comprises retaining features configured to retain the inlays inside their respective reception chambers.

3. The connector assembly according to claim 1, wherein each terminal is crimped onto a cable.

4. The connector assembly according to claim 3, wherein the cable is a part of a twisted wire pair.

5. The connector assembly according to claim 1, wherein at least one inlay comprises:
a rear grid disposed on a rear side of the inlay, the grid having a plurality of feed-through apertures configured to receive electrical contacts;
a sealing insert mountable to the rear grid, wherein the sealing insert has feed-through holes for receiving the electrical contacts; and
an elongated insert module mountable to the sealing insert, sandwiching the sealing insert between the rear grid and the elongated insert module, said module comprising at least two cavities configured to receive electrical contacts.

6. The connector assembly according to claim 5, wherein the sealing insert is made of an elastomeric material.

7. The connector assembly according to claim 1, wherein the inlay has a substantially flat rectangular shape, having a length in an insertion direction and a height and wherein a ratio of length:height is at least 7:1.

8. The connector assembly according to claim 1, wherein the inlay has a substantially flat rectangular shape, having a length in an insertion direction, and a width and wherein a ratio of length:width is at least 7:1.

9. The connector assembly according to claim 1, wherein each inlay has two channels extending in insertion direction from one end of the inlay to an opposite end, for the reception of electrical contact terminals.

10. The connector assembly according to claim 1, wherein at least one inlay has a T-shape, and coding feature and fixing feature are arranged in the bar of the T-shape.

11. The connector assembly according to claim 1, wherein the housing comprises a TPA device.

12. The connector assembly according to claim 1, wherein each inlay comprises a TPA device.

13. The connector assembly according to claim 1, wherein the housing comprises at least two matching sub-housings each comprising sub-housing connection feature, the sub-housing connection feature being configured to fit together like two pieces of a jigsaw to connect two sub-housings with each other to form the housing.

14. The connector assembly according to claim 13, wherein the sub-housing connection feature comprise dovetail joints.

15. The connector assembly according to claim 14, wherein the sub-housing connection feature comprise sliding dovetail joints.

16. The connector assembly according to claim 13, wherein the sub-housing connection feature comprise locking feature configured to lock the sub-housings in a final position.

17. The connector assembly according to claim 1, wherein the inlays comprise polarization feature, configured to allow one insertion orientation into the reception chambers, wherein the polarization feature is preferably a polarization rib, which polarization rib is preferably axially extending in a mating direction of the inlays.

18. The connector assembly according to claim 17, wherein the polarization feature is a polarization rib axially extending in the mating direction of the inlays.

19. A method of connecting an inlay for a connector assembly having a housing and a plurality of inlays, each inlay being configured to receive two terminals of a wire pair, wherein the housing comprises inlay reception chambers configured to receive the inlays, the method comprising the steps:
a) providing the inlay, the twisted wire pair comprising two wires each having a terminal attached thereto, and a twisting machine;
b) twisting the two wires of the twisted wire pair using the twisting machine;
c) while the twisted wire pair remains engaged with the twisting machine, inserting the terminals attached to the twisted wire pair into corresponding terminal-receiving channels or cavities of the inlay such that the inlay mechanically receives the terminals; and
d) after step c), mounting the inlay into one of the inlay reception chambers of the housing.

20. The method of connecting an inlay according to claim 19, wherein the twisting machine comprises a gripping device, and wherein the gripping device maintains engagement with the twisted wire pair during step c).
